(19) United States
(12) Patent Application Publication
(10) Pub. No.: US 2009/0138408 A1
(43) Pub. Date: May 28, 2009

(54) Automated Renewable Scholarship

(76) Inventor: Joseph P. Kincart, Carmel, NY (US)

Correspondence Address: Joseph P. Kincart, Esq., 8153 Middle Fork Way, Jacksonville, FL, 32256, US

(21) Appl. No.: 12/040,861

(22) Filed: Feb. 29, 2008

Related U.S. Application Data
(63) Continuation-in-part of application No. 11/216,465, filed on Aug. 31, 2005, now Pat. No. 7,389,181.
Application No. 11/216,465 is a division of application No. 09/994,513, filed on Nov. 26, 2001, now abandoned.

(51) Int. Cl. G06Q 40/00

(52) U.S. Cl. 705/36 R

(57) ABSTRACT

A computerized method and system for facilitating and brokering investment in a scholarship candidate is disclosed. A vehicle is provided for modeling an expected return on investment made in a scholarship candidate based upon historical, demographic and other related data. The return on the investment is commensurate with the success of the scholarship candidate. A portfolio of potential scholarship candidates can also be created, such that an investment can be made in the portfolio of scholarship candidates. A return on investment can be received based upon the performance of the portfolio aggregate. Qualifications that are considered desirable for a scholarship candidate can be rated according to standardized terms or be highly subjective. Terms of a scholarship contract can provide for a scholarship candidate to receive funding in the near term in order to pursue an educational endeavor in return for a covenant to fulfill contract terms at a later date.

### CROSS REFERENCE TO RELATED APPLICATIONS

The present application claims priority to, as a Divisional Application, to pending patent application Ser. No. 09/994,513, filed, Nov. 26, 2001 and entitled, “Automated Renewable Scholarship” the contents of which are each relied upon and incorporated by reference.

### BACKGROUND

This invention relates to a method and system for facilitating automated scholarship and reimbursement. In particular, the present invention relates to a computerized system and method for structuring a financial model and transaction that enables an educational institution or interested third party to award a scholarship to a scholarship candidate and receive future compensation therefore.

Currently it is commonplace to provide educational scholarships in the form of funding to a student whom a scholarship provider determines has a high likelihood of success. Students who are potential recipients compete for finite funds that can be utilized to finance an education. Once the funds have been dispersed, additional funds must be raised or the cycle ceases. The net result is that some students with extraordinary ability to contribute to society never receive the opportunity to attend the college most suited to their talent and ambition.

The current system is also flawed in that if the student is successful, the student's success may add prestige to the learning institution the student attended and to a lesser extent the scholarship provider, however, the scholarship provider realizes little or no tangible benefit. The student, on the other hand, will have benefited from the education provided for by the scholarship and have no duty, other than a moral obligation to reciprocate. Since providing scholarships is a net loss proposition, this traditional scholarship model is limited in the number of students that it can assist. As scholarships are provided, additional monies must be raised in order to provide additional scholarships.

In addition, a student who does not receive all necessary funding through scholarship, and cannot otherwise afford educational costs, must secure funding through an alternative source, such as a loan. Loans are taken for a set sum that the student is required to repay, as well as interest compounded at an agreed upon interest rate. Essentially, a student with little practical knowledge of the world of finances is forced to make an investment beyond their means in the hope that a chosen educational pursuit will provide them with a return on investment sufficient to repay the loans at a later date. If the student's educational endeavor does not provide them with a relatively high earning capacity, the financial burden of paying back the loans may be substantial, or even overbearing. On the other side of a loan, a loan provider will usually receive a fair return on investment, but the return will not have a potential upside that can accompany other investments.

In another case, a deserving student who has the necessary qualifications to enter into an Ivy League school or other first tier learning institution may not have the means of financing such an ambitious endeavor. The student with this type of opportunity may gladly forgo a portion of future rewards in order to gain the life changing experience that an excellent education offers.

What is needed is a method or system that can provide renewable scholarship funding while also providing a potential upside to a scholarship investor. In order to be most efficient, the method and system must allow for an equitable ratio of payback to the recipient of the scholarship funds and also increase the availability of funds to those individuals willing to take necessary actions to increase their earning potential or pursue some other worthy goal.

### SUMMARY

Accordingly, the present invention provides a method and system to facilitate investment in a scholarship candidate. In return for the investment, the scholarship candidate agrees to remunerate a scholarship provider at a rate commensurate with the candidate's success. Remuneration can be structured to include various forms of value added to include a percentage of future earnings for a term of years, contribution of assets or services, or other value added to the scholarship provider or a designated beneficiary. A remuneration period can commence with the occurrence of a trigger event, such as graduation, or at a predetermined date. A computerized system is utilized to perform necessary functions to act as an investment exchange and otherwise facilitate the investment process.

The present invention includes a computer-implemented method for facilitating financial investment in a scholarship contract. Informational data descriptive of a scholarship candidate is received or gathered into a computer. Criteria for investment are also received such that the informational data can be analyzed according to the investment criteria and an analysis of the informational data according to the investment criteria can be presented. An investment instruction can be made to make funds available according to terms of a scholarship contract. A transaction can be executed responsive to the investment instruction received.

A computer system can model an expected return on investment according to the scholarship contract terms and expectations for future performance of the scholarship candidate. A success rating indicative of the scholarship candidate's expected performance can also be calculated. In one embodiment, the success rating can be calculated according to a success algorithm. The success algorithm can be refined as additional data is received.

In one aspect of the present invention, an investment vehicle, such as a limited liability company, can be formed to invest in a scholarship contract. A computer system can receive an investment instruction to make an investment in the investment vehicle.

The status of a scholarship candidate and fulfillment of contract terms can be tracked such that the system can allocate contract fulfillment funds according to associated contract terms. Tracking can also allow updated data descriptive of the scholarship candidate status to be input. An associated algorithm can be refined responsive to the input data descriptive of the scholarship candidate status. An associated system can present informational data relating to candidates or market variables, research, or other related material via a graphical user interface.

In another aspect, the present invention includes a computer implemented method for administering a financial product so that the financial product can be traded as a security. The price of the financial product can be determined on the basis of information about a scholarship contract. The method includes identifying a portfolio of scholarship contracts and receiving informational data relating to the portfolio. The informational data can include, for example, average salaries for graduates from an educational program similar to the one a scholarship candidate would like to embark upon. A price can be determined for the financial product on the basis of the informational data. For the purposes of this invention, a portfolio can include a single scholarship contract.

In addition to the financial product, an option based upon the financial product or even a single contract can be traded. A price for an option to purchase the financial product can be based upon market data and demand, for example the price of the option can relate to a calculated annual income associated with a scholarship candidate that is party to the scholarship contract. An option price can also reflect a decreased value for the annual income as compared to a current value or an increased value for the annual income as compared to a current value.

In another aspect, a method of facilitating financial investment in a scholarship contract is disclosed. An investment vehicle can be formed and informational data relating to scholarship contracts can be received. The informational data can be analyzed to ascertain if any of the scholarship contracts fit in with an investment objective. Money can be transferred into the investment vehicle and the investment vehicle can make an investment in a scholarship contract according to the analysis.

If the investment vehicle has multiple membership interests, the computer system facilitating the scholarship investment can also be utilized to track and evaluate a membership interest in the underlying investment vehicle commensurate with a capital contribution to the investment vehicle. One example of an investment vehicle can include a charitable lead annuity trust, another example can include a limited liability company.

If a charitable lead annuity trust is utilized, expected returns from investment in the scholarship contract can be combined with yield requirements of the charitable lead annuity trust such that a model of financial investment an be displayed. The model can include a charitable lead annuity trust funded by the expected returns from investment in the scholarship contract and relate to an investment objective. Distribution of funds to a predetermined beneficiary upon expiration of a lead term of the charitable lead annuity trust can also be tracked.

In still another aspect, a contract can be created with terms designating a return on investment commensurate with a scholarship candidate's future success. The contract can be stored on a computer server. The server can be accessible via a distributed network, such as the Internet. The server can be utilized to present the terms of the contract via a graphical user interface, wherein the interface can receive an instruction designating a party to the contract.

Other embodiments include a computer server to implement the above methods via executable software stored on the server. If desired, the executable software can be executed on demand via the network access device over a communications network. A network access device will typically be an electronic device such as a computer or wireless digital assistant and conform to the transmission control protocol/internet protocol.

Additionally the present invention can include a WEB interface for accessing the executable software stored on the server storage medium, or a method of interacting with a graphical user interface so as to facilitate a financial investment utilizing the above methodologies.

Still other embodiments include computer executable program code residing on a computer-readable medium or a computer data signal embodied in a digital data stream.

The details of one or more embodiments of the invention are set forth in the accompanying drawings and the description below. Implementations can provide advantages such as standardized funding for student's attending a learning institution. Other features, objects, and advantages of the invention will be apparent from the description, the drawings and the claims.

### DESCRIPTION OF THE DRAWINGS

FIGS. 1a and 1b illustrate block components involved in an automated scholarship candidate investment system.

FIGS. 2a, b and c illustrate exemplary flows of method steps included in the present invention.

FIG. 3 illustrates a network embodiment of the present invention.

FIG. 4a illustrates a user interface with functionality included in the present invention.

FIG. 4b illustrates a user interface with additional functionality included in the present invention.

FIG. 5 illustrates a presentation of analysis of potential return on investment available from a scholarship contract.

FIG. 6 illustrates an exemplary flow of steps in a process which allows a scholarship recipient to designate a subsequent scholarship candidate to receive a scholarship.

### DETAILED DESCRIPTION

The present invention includes a computerized method and system for facilitating and brokering investment in a scholarship candidate. It can provide a vehicle for modeling an expected return on investment made in a scholarship candidate based upon historical, demographic and other related data wherein the return on the investment is commensurate with the success of the scholarship candidate. In addition, the present invention can create a portfolio of potential scholarship candidates such that an investment can be made in the aggregate of scholarship candidates included in the portfolio, and a return on investment can be received based upon the performance of the portfolio aggregate.

Qualifications that are considered desirable for a scholarship candidate can be rated according to standardized terms or be highly subjective and specifically tailored to an individual scholarship. Similarly, scholarship contracts can be generated which contain standardized terms and conditions or with terms that address specific needs and/or interests of a scholarship provider, scholarship candidate, educational institution, charitable institution, philanthropic entity, investment facilitator, broker or other party related to the renewable scholarship process. Generally, terms of a scholarship contract provide for a scholarship candidate to receive funding in the near term, in order to pursue an educational endeavor, in return for a covenant to perform a specified action at a later date. The action can include, for example, sharing future earnings or net worth.

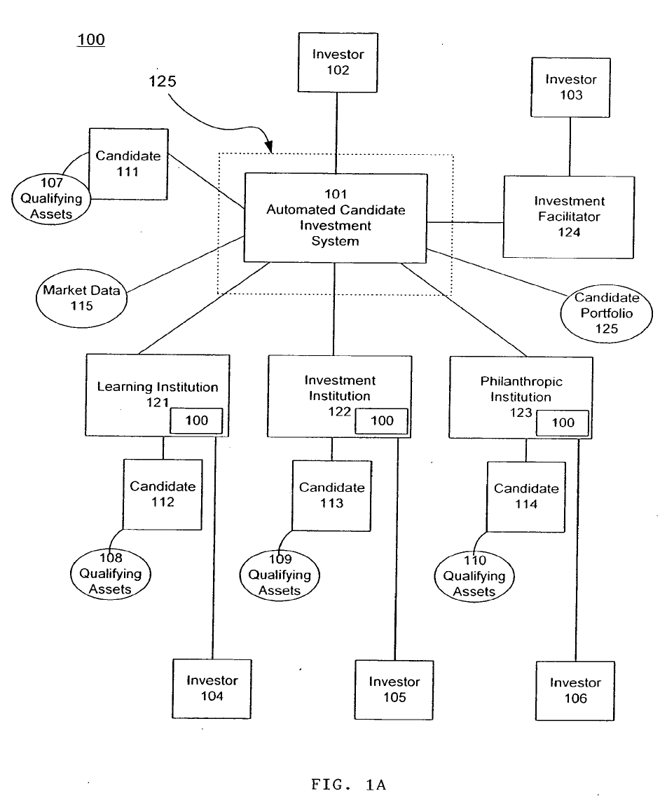

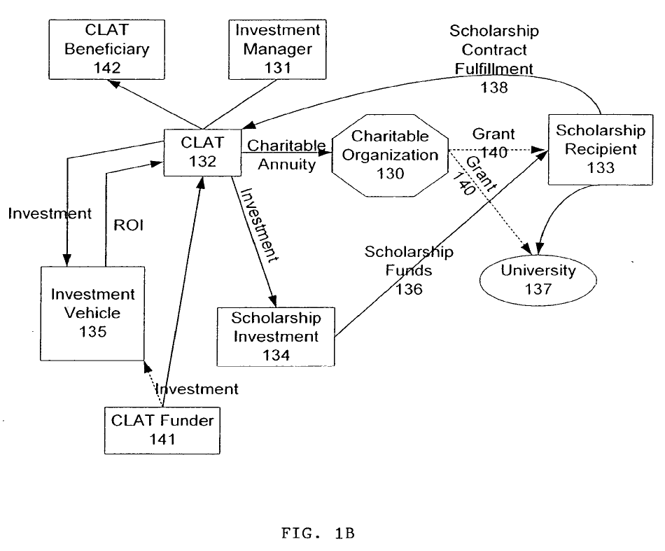

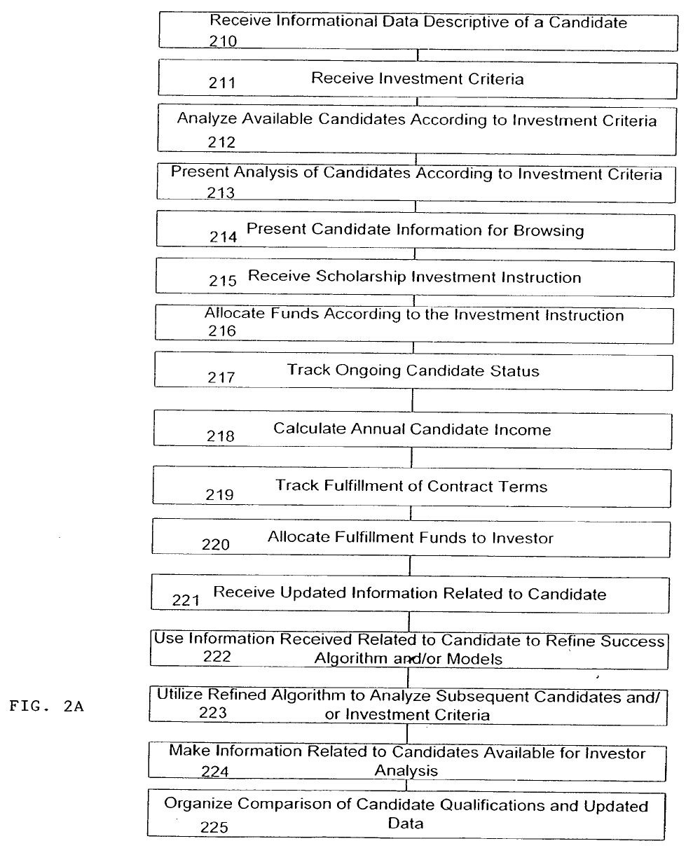

Referring now to FIG. 1, a block diagram 100 is illustrated representing major components involved in the present invention for investment in one or more scholarship candidates and modeling a scholarship contract according to goals supported by investment, philanthropic and/or charitable motives. An automated scholarship investment (ASI) system 101 can receive objectives of a scholarship investor 102-106 and model expected results from a scholarship investment in a specific individual or set group of individuals and determine whether such investment is suited to meet multifaceted objectives of a scholarship investor 102-106. A scholarship investor's 102-106 multifaceted objectives can include for example, philanthropic motive, political purpose, religious purpose, income generation, or obligation to a scholarship system. Alternatively, an ASI system 101 can receive objectives of a scholarship candidate 111-114 and model results the candidate 111-114 can expect if they enter into a specific scholarship contract.

The ASI System 101 acts as a vehicle to facilitate the exchange of information between scholarship candidates 111-114, scholarship investor 102-106, institutions 121-123 and/or a scholarship facilitator 124. In addition, the ASI system 101 can act as an exchange or other vehicle for the execution of a scholarship investment transaction. Qualifications descriptive of a scholarship candidate's 111-114 attributes and/or accomplishments are input into the ASI system 101. Such qualifications can include, for example, talents, experience, accomplishments, educational endeavors, educational institutions and/or curriculums to which a candidate 111-114 is admitted or other information indicative of the character or capability of a candidate 111-114. The qualifications are preferably input as electronic data. However, informational data comprising hardcopy documents, oral interviews or other sources can also be received, scanned, transcribed or otherwise input into the ASI system 101. Images of hard copy documents can be viewed or transmitted, such as by fax. In one embodiment, a scholarship candidate 111-114 can present qualifications to a learning institution 121, investment institution 122, philanthropic institution 123 or other intermediary acting as a facilitator 124, such that the facilitator will input the qualifications to the ASI system 101.

A facilitator may take many forms including a scholarship “broker” or a proponent of a particular cause. Typically, a facilitator 104 will present qualifications of a scholarship candidate 111-114 in a manner conducive to the facilitator's 104 agenda. For example, a scholarship broker, acting as facilitator 104, may receive a fee for each scholarship contract brokered. In order to maximize interest in investing in scholarships, the broker may present qualifications according to the likelihood of financial success. Another facilitator 104 may seek to promote a humanitarian, religious, political or artistic agenda and present qualifications according to a likelihood of promoting such an agenda.

The ASI system 101 can store and organize candidate qualifications as electronic data which can be presented to a scholarship investor 102-106 to facilitate investment in a scholarship candidate 111-114. Presentation to the scholarship investor 102-106 may include an offer with terms under which a scholarship candidate 111-114 will accept a scholarship. In one preferred embodiment, a scholarship investor 102-106 can accept an offer for investment in a scholarship for a particular scholarship candidate 111-114 or group of candidates and a scholarship contract can be executed with a digital signature or other electronic mechanism for creating a legally binding artifact. A corresponding scholarship candidate 111-114 can also be made a party to the scholarship contract in a similar fashion. The scholarship contract can be embodied in a hardcopy document and/or by electronic means.

Different scenarios can allow for a scholarship investor 102-106 to make an offer which a scholarship candidate 111-114 can accept, such as with an electronic signature or authorization code. Alternatively, the scholarship candidate 111-114 can first put forth acceptable terms of investment that constitute a legally binding offer which a scholarship investor 102-106 can accept. If necessary, multiple iterations of offer and counter offer can take place before an investment agreement is reached.

In order to facilitate the investment process, an investor can arrange for a pre-authorized line of credit. One credit arrangement can include a credit line collateralized by another asset. Assets can also be leveraged if desired. Other credit arrangements can include charging a credit card or debit card.

A scholarship investor 102-106 can include an individual or institution that seeks a profitable return on investment, or that seeks to fulfill a philanthropic motive. In addition a scholarship investor 102-106 can include an individual or institution who decides to invest in the future of a human being, or group of human beings, as opposed to the future of a financial instrument, a business, a commodity, or other currently available structured investments. The ASI system 101 can also offer a unique ability to perpetuate a contribution designed to promote a particular endeavor. Depending upon the size of the scholarship investment and/or the structure of the scholarship investment, a scholarship investor 102-106 may be required to be a qualified investor according to Securities Exchange Commission guidelines.

Return on an investment in a scholarship can include: monetary return, such as a portion of a scholarship candidate's 111-114 future earnings for a term of years; fulfillment of an agreed upon goal, such as a philanthropic endeavor; a commitment to provide value to a beneficiary, such as a commitment to provide for a future scholarship investment in a subsequent candidate 111-114 or a transfer of cash or a valuable asset to a predetermined beneficiary; or other consideration. A portion of future earnings can be structured, for example, as a percentage of income for a specific period in a scholarship candidate's 111-114 career, or a percentage of net worth during a term of years or other such arrangement meant to capture and share the pecuniary success of the scholarship candidate 111-114.

In one embodiment, a graduated scale can be utilized to lessen the burden of the candidate during the early years of their career and also improve the return on investment for the investor. For example, during the first years directly following graduation from a university, a scholarship candidate's 133 income and net worth may be relatively low. During these early years it may be negotiated that a smaller percentage of income be allocated to pay back the scholarship investor 102-106. During the later years, such as the tenth through fifteenth year following graduation, statistics may indicate that the candidate will be financially sound and of higher net worth. Accordingly, it may be negotiated that the candidate will repay a higher percentage of earnings during those later years, or allocate a portion of the candidate's net worth at some designated point in time, to the scholarship investor 102-106. Options on repayment method can be negotiated wherein the candidate 111-114 or the scholarship provider 102-106 is allowed to opt amongst multiple repayment options specified in the contract.

Fulfillment of a philanthropic endeavor can include, for example, accomplishment of a goal that benefits society, a term of years working in a charitable capacity, promotion of a disadvantaged social group, advancement of an ethnic or religious group, work towards world peace, or other objective a scholarship investor 102-106 may wish to promote. In one embodiment, a contract may specify that commitment to a percent of earnings for a term of years will be forgiven in return for service rendered to an agreed upon charity.

Commitment to provide value can allow an initial scholarship candidate 111-114 who received a scholarship to perpetuate the provision of scholarships. In addition, it can provide personal satisfaction to an initial scholarship candidate 111-114 by allowing the initial scholarship recipient to select a subsequent scholarship candidate 111-114 according to the initial scholarship recipient's own criteria and promote an ideology or professional agenda of their choice.

Terms of a scholarship contract can vary according to the agenda held by each party and the relative bargaining position of each party. The terms can include almost any other exchange of value and are not limited to a portion of a scholarship candidate's 111-114 future earnings. For example, terms of a scholarship contract may require that a scholarship candidate 111-114 be responsible for arranging value, such as a donation, be received by a charitable organization that provides scholarships. This example may be particularly useful in the case where a relative, such as a grandparent, may wish to help relieve their grandchild's contractual obligation and can do so by donating to the charitable organization. It can also be useful for those situations where a scholarship candidate 111-114 dedicates their career to an endeavor that is not highly compensated but furthers an idealistic goal, such as a religious or aid worker. Often benefactors are willing to assist such idealistic endeavors with donations which can be directed to satisfy the scholarship candidate's 111-114 contractual obligation.

A scholarship candidate 111-114 possessing attributes which are in demand by scholarship investors 102-106 may be able to attract multiple offers from scholarship investor 102-106 willing to invest in the scholarship candidate's 111-114 future. With multiple offers available, the scholarship candidate 111-114 may be able to negotiate terms of a scholarship contract, or other investment vehicle arranged by the ASI system 101, that are more favorable to the scholarship candidate 111 -114.

A scholarship candidate 111-114, possessing more generic attributes may be able to attract investment, but may have to agree to contract terms that are more strenuous. Strenuous contract terms may include a greater percentage of future earnings, specific performance of non-income related conditions, or other terms that are designed to meet a scholarship investor's 102-106 agenda. In one embodiment each contract can have terms and conditions that are tailored to a specific situation at hand and specifically address the investment goals of the scholarship investor 102-106 as well as the life management goals of the scholarship candidate 111-114.

In another aspect, an ASI system 101 can provide a scaled rating indicative of a degree of confidence in a scholarship candidate's 111-114 likelihood of success. A highest degree of confidence can correspond with a high rating, such as an A+ rating or a 100 rating. Additional degrees of confidence can be indicative of incrementally diminishing confidence in the scholarship candidate's 111-114 likelihood of success. Other rating scales can also be utilized.

A candidate confidence rating can be based upon objective or subjective data. Objective data might include test scores, academic accomplishments, entrepreneurial success, admission into an Ivy League learning institution, pursuit of a high income profession, and any other quantifiable data describing a scholarship candidate 111-114, the scholarship candidate's 111-114 purported career goals, or situation. Subjective data can include a scholarship investor's 102-106 or other rating person's intuitions about a scholarship candidate's 111-114 prospects. Subjective intuitions can be fostered by an interview, written materials submitted by the scholarship candidate 111-114, qualities or talent indicated by the scholarship candidate's 111-114 work, recommendations or other input. One embodiment can include professional raters trained to analyze a candidate 111-114 and provide input to be utilized to calculate a confidence rating.

Qualifications utilized to calculate a confidence rating, or independently utilized by a scholarship investor 102-106, can include the reputation of an educational institution that a scholarship candidate 111-114 will attend, the scholarship candidate's 111-114 grade point average, activities the scholarship candidate 111-114 engages in, the scholarship candidates educational major, accomplishments, IQ score, education completed, demographic data, a current position, past experience, expertise, market data, past accomplishments or other data and almost any other data related to a scholarship candidate 111-114 or investment objective.

Analysis can include market data quantifying the types of positions held by individuals with similar qualifications and talents, average compensation for such positions, career progression, or other data relating to a particular field of endeavor entered into by a scholarship candidate 111-114. In addition, external market conditions such as an indicator descriptive of the national economic condition, strength of an industry, interest rates, inflation, demand for a chosen profession or other general data can also be utilized to conduct analysis.

The ASI system 101 can also combine projected returns from a scholarship candidate's 111-114 intended career objectives with the educational pursuits of the participant and make a determination regarding the future benefit that may be received for sponsoring a scholarship candidate 111-114 embarking on an educational pursuit or business venture.

In one embodiment, a confidence rating is calculated with success criteria which are quantified and weighted according to relative importance. A value is calculated for each criterion that pertains to a scholarship candidate 111-114 according to data received descriptive of attributes of the scholarship candidate 111-114. The criteria value is multiplied by the weight assigned to each criterion to calculate a criteria score. Each criteria score is added together such that an aggregate sum of the criteria scores can be calculated to equal a confidence rating.

Standardized scholarship contracts, which can be associated with a confidence rating, can also be utilized to facilitate an automated scholarship investment process. A series of standardized scholarship contracts can capture investment terms representing a graduated scale of favorability, similar to or even corresponding with a confidence rating. At one end of the scale, the terms of the contract may be written to reflect great confidence in the future of a scholarship candidate 111-114. At the other end of the scale terms can indicate a more moderate, or even negative view of a scholarship candidate's 111-114 future. Terms reflecting moderate interest in investment will most likely indicate some measure of confidence by the scholarship investor 102-106 in the scholarship candidate's 111-114 ability to succeed. Following this example, a scholarship contract corresponding with a low confidence rating may contain terms that are most strenuous on the scholarship candidate 111-114. However, even a scholarship contract corresponding with a low confidence rating will enable a scholarship candidate 111-114 to pursue an education that might otherwise be unavailable to the scholarship candidate 111-114.

Scholarship contracts can also have different classifications or levels indicative of the relative bargaining power of a scholarship investor 102-106 and a scholarship candidate 111-114. As mentioned above, contract levels can correlate with a confidence rating in a scholarship candidate 111-114. Each contract level can be indicative of standard underlying terms and conditions. Standardization can be useful in that both parties can be assured as to the terms they are entering into without undue analysis, such as review by an attorney. Research and commentary relating to the terms contained in contracts associated with various levels can be circulated such that parties entering into a particular contract can be better educated as to their expectations regarding such a commitment.

For example, a series of contracts can quantify an arrangement whereby, in return for money invested in the scholarship candidate's 111-114 education, the scholarship candidate 111-114 agrees to pay a predetermined set percentage or a variable percentage of the scholarship candidate's 111-114 salary for a term of years following completion of the education. A candidate's increased earning capacity resultant to the completed education thereby benefits both the scholarship recipient 133 and the scholarship investor 102-106 who funded the education in return for a percentage of the scholarship candidate's 133 future earnings. One embodiment can include a variable percentage of a scholarship candidate's salary during a payback term. The percent of salary can be determined by a salary range for the candidate during a particular year, be graduated according to the year of payback, be front or back end weighted, or according to some other schema.

In another aspect, a level one contract may call for 5% of a scholarship candidate's 111-114 salary for a period of eight years, that commences three years following completion of an agreed upon educational endeavor such as graduation from medical school, while a level three contract may require a payback of 10% for a period of twelve years commencing four years after completion of the agreed upon educational endeavor.

Scholarship contracts may also call for a pay-back period to commence upon a triggering event, which can include, for example, withdrawal from enrollment in an agreed upon learning institution or exiting from an agreed upon activity. Typically, a scholarship candidate 111-114 who demonstrates a high probability of success will be able to negotiate either a lower percentage of earnings, shorter term of pay back years and/or other terms favorable to that candidate 111-114.

Standardized contracts can also facilitate the creation and maintenance of a liquid market for contracts at various states of maturity. A scholarship investor 102-106 who has obtained a contract early in a scholarship candidate's 111-114 career can have the option to later market the contract. Preferably, an exchange will list available scholarship contracts as well as market data related to the sale of scholarship contracts. Contracts may increase or decrease in value depending upon the performance of a correlating scholarship candidate 111-114, or group of scholarship candidates. In addition, market data can affect the value of an investment. In a strong economy, the value of an investment in a scholarship contract associated with a particular industry or academic pursuit may be valued relatively high, while a weak or receding economy may be more beneficial to other sectors or curriculum. Other factors can also affect the market value for a particular contract or pool of contracts.

A financial model based upon the present invention can include expected returns based upon an analysis of qualifications of an individual scholarship candidate 111-114 or upon an aggregate of scholarship candidates associated in a portfolio or “mutual fund” of scholarship candidates. Data considered in the analysis can include scholarship candidate 111-114 qualifications and marketable talents as well as stated objectives of the participants.

In one embodiment, the computer model generated by the ASI system 101, or other computer, can systematize analysis for multiple participants with various qualifications and backgrounds. Amongst other functions, analysis can include grouping multiple participants together in order to create a hedge or otherwise diminish risk associated with a scholarship investment. In one example, a group of scholarship candidates with similar attributes can be formed into a portfolio. In this case, investment in the portfolio can reflect a particular market segment and yet be insulated from the peculiarities that may be associated with a specific scholarship candidate 111-114. Hedging may also be conducted across industries or sectors, according to geographic regions, across chosen professions, amongst various demographic groups or any other combination of factors. In addition, hedging can be utilized within a homogeneous group of scholarship candidates whereby risk is not associated so much with an individual scholarship candidate 111-114, but with a group of scholarship candidates with similar attributes. Analysis of a hedged group can include expected return on investment, likelihood of success in achieving a particular goal, quantification of a particular need, or other inquiry. Hedging criteria may be utilized to assist scholarship candidates with differing educational or professional pursuits, different backgrounds, multiple age groups, from different geographic regions or nationalities, various success criteria, and any other quality that may decrease the likelihood of a loss on investment, but still maintain reasonable returns.

Accordingly, scholarship candidates can be grouped together to form a portfolio for investment, thereby forming a “mutual fund” of investment opportunity in scholarship candidates. A scholarship candidate portfolio 125 can be created to address various investment criteria, such as those listed above for analysis. For example, a portfolio 125 can be created to invest or promote a particular industry or cause without being limited to one individual.

A portfolio 125 can also be designed to meet criteria specified by a donor or scholarship investor 102-106. Specified criteria can include almost any ascertainable purpose or data. Some examples of specified criteria may include: scholarship candidates with a specific accomplishment, such as previous commercial success, recipient of an award or other designation; scholarship candidates obtaining a minimal score on a standardized test, scholarship candidates with a particular ethnic background, scholarship candidates who practice a particular faith, scholarship candidates pursuing a specific educational curriculum, scholarship candidates from a particular geographic area, or any other criteria that may satisfy a personal, social, religious or philanthropic motive of a scholarship investor 102-106.

The ASI system 101 can also receive as input, a scholarship investment objective put forth by a scholarship investor 102-106 or group of scholarship investors 102-106. The ASI system 101 can model one or more financial structures through which the objective can be fulfilled. In addition, financial structures can combine investment objectives with market data and model suggested investments. Market data can include information relating to educational institutions, demographics, personal attributes of participants, economics trends, employment data and other data that relates to potential returns or personal objectives. The ASI system 101 can calculate expected cash flow and other financial benefits based upon market data. A financial investment structure modeled by the ASI system 101 can include factors pertaining to a specific individual, a learning institution, a demographic group or other criteria.

A scholarship investor 102-106 may have multifaceted objectives for a potential investment. For example, a scholarship investor's 102-106 objective may include a philanthropic motive, political purpose, religious purpose, income generation, fulfillment of an obligation to a scholarship system, a targeted return on investment, charitable intent, tax planning and/or estate planning, or other objective. The ASI system 101 can execute a transaction causing an investment to be made in one or more scholarship candidates that indicate a propensity for fulfilling some combination of the objectives and track progression of the investment through a term of years. In addition, actual scholarship investment experience can be utilized to further refine subsequent models of financial structures.

A negative view of the future of a candidate with specific attributes can be represented by an option that reflects a decreasing value for a contract that captures the scholarship candidate's 111-114 future earnings for a term of years. In essence, an option can sell short the contract on the scholarship candidate's 111-114 future.

Referring now to FIG. 1b, another embodiment of the present invention can include can include purchasing an interest in an investment entity 135, such as a limited liability company (LLC) which is utilized to make one or more investments in the future earnings of one or more scholarship candidates. If desired, the investment entity 135 can be a single member LLC formed on behalf of the scholarship investor 102-106. For the purposes of this invention, an LLC can be an unincorporated organization that provides limited liability to its members, regardless of the extent of their participation in the management of the LLC. Advantages of investing through an LLC can include protection for a scholarship investor 102-106 as a member of the LLC: In their capacity as members of the LLC, the scholarship investors may not be personally liable for the debts, obligations or liabilities of the LLC, except to the extent the members agree to be personally liable pursuant to an agreement and except that members may be obligated to repay any amounts wrongfully distributed to them. Absent an affirmative election to treat a single member LLC as an association taxable as a corporation, a single member LLC can presently be treated as a disregarded entity for federal income tax purposes (i.e., as a sole proprietorship if owned by an individual). Other legal organizations with similar or different advantages may also be utilized as an investment entity 135.

An investment vehicle can make use of a charitable lead annuity trust (CLAT) 132 to meet investment objectives of a scholarship investor 102-106 and also provide for investment in a scholarship candidate 111-114. For the purpose of this invention, a CLAT 132 is a legal entity which can be established for a fixed number of years (the “Lead Term”), with a fixed amount being paid to a charity (the “Charitable Lead Annuity”), during that period. A scholarship investor 102-106 that makes use of a CLAT 132 can receive a charitable gift tax deduction for transfer tax purposes. In one embodiment, the charitable transfer tax deduction can be valued at up to 60% of an initial asset used to fund the CLAT 132. A charitable gift can be valued at the present value of a charitable lead annuity payment during a Lead Term, as computed according to IRS guidelines. A scholarship investor 102-106 can utilize lifetime estate and transfer tax credits, or pay transfer tax, on the remaining initial value used to fund the CLAT 132.

An investment entity manager can manage investments in scholarship candidates included in the CLAT 132. In one embodiment, an investment entity manager can act under authority of an investment contract. Under the terms of the investment contract, the investment entity manager can invest capital contributed by an investment entity 135 jointly and severally with the capital of one or more other investment entities 124. Each investment entity can then own an undivided, fractional interest in scholarship candidate 111-114 investments and pay its proportionate share of scholarships or other costs. In turn, each investment entity 135 can receive its proportionate share of the proceeds in the form of cash flow and other benefits as well as income tax attributes from donations to charitable organizations. In another embodiment, all capital received from one investment entity 135 can be fully segregated and invested separately from capital received from any other investment entity 135.

Referring now again to FIG. 1b, a scholarship candidate 111-114 that receives a scholarship according to this invention can be viewed as a scholarship recipient 133. In one exemplary embodiment, a scholarship investor 102-106 can fund a CLAT 132 and become a CLAT funder 141. The CLAT 132 will make a scholarship investment 134 that provides scholarship funds 136 to the scholarship recipient 133. The scholarship recipient 133 can pursue an educational endeavor and make payments into the CLAT 132 according to scholarship contract fulfillment terms 138. The CLAT 132 would also make statutory contributions to a charitable organization 130. If desired the charitable organization 130 could also award a grant 140 or other benefit to the scholarship recipient 133 or an associated learning institution such as the university the scholarship recipient will attend.

A CLAT funder 141 provides funds a CLAT 132 which provides value to the affiliated charitable organization 130 in the form of a cash donation, such as an annuity. The CLAT funder 141 receives associated tax benefits, including potential transfer tax benefits to a CLAT beneficiary 142, as well as a potential upside return on investment from the CLAT 132 investing in the scholarship investment 134. The university 136 receives tuition funds as well as possible grant funds, and the scholarship recipient 133 receives an education.

Alternatively, an investor 102-106 can make a straight donation to a charitable organization 130 which will be directed to a scholarship recipient 133 and participate in the terms of a scholarship contract offered to the scholarship recipient 133. Properly structured according to a present tax code, the investor 102-106 may be able to receive a tax benefit as well as a potential upside. In still another alternative, the investor may be able to receive a tax benefit and direct a future obligation of service on the part of the scholarship recipient 133 to a particular organization, either charitable or industrial.

An investment manager 131 can be utilized to facilitate an investment and take over day-to-day management of the CLAT 132. An investment manager 131 or other party, can use the ASI system 101 to model and track a scholarship investor's 102-106 scholarship related investments as well as offers made by a scholarship investor 102, fees, annuity payments, accounts payable, receivables and other related information. For example, The ASI system 1010 may track standard fees such as a formation fee or a management fee, payments specific to a particular scholarship candidate 111-114, monies associated with an equity share in the scholarship candidate's 111-114 future, a commission for an award of a scholarship, or a commission received as a percentage of a scholarship pay-back.

The ASI system 101 can also model and track conveyance of a portion of an ownership interest associated with an investment vehicle 135, or a CLAT 132, organized for a scholarship investor 102-106. Cash flow generated by investment in a scholarship candidate 111-114 or scholarship candidate portfolio 125, or other benefit resultant to a CLAT 132 or other investment vehicle 135 ownership, can be distributed to a beneficiary in the form of an annual or other scheduled annuity. Cash flow in excess of a charitable lead annuity can be accumulated in an associated CLAT 132. After a charitable obligation is satisfied, accumulated cash may be eligible to be distributed to designated heirs free of transfer tax.

If a donor advised fund is used in conjunction with a CLAT 132 or other investment vehicle, the donor advised fund can be designated as the charitable organization 130 that is the beneficiary of the charitable contribution or annuity. Utilization of a donor advised fund allows an ASI system 101 to receive instructions to direct money held in the fund to a particular charity, or even to a scholarship candidate 111-114 or portfolio 125 and track allocation of the funds according to the instruction received. In addition, the ASI system 101 can display charitable giving history detailing the allocation of funds related to a particular CLAT 132. Accordingly, it is possible for a scholarship investor 102-106 to fund a donor advised fund and advise on its distribution over a term of years that is longer than the lead term of the trust. For example, a donor may accumulate $90,000 in a donor advised fund through six consecutive annual donations of $15,000 each and then direct the distribution of the $90,000 from the donor advised fund for a term of years extending beyond the six years.

If desired, a computerized ASI system 101 can be used to model organization of scholarship candidate 111-114 scholarship contracts such that the scholarship contracts are designed to meet specific predetermined investment, tax, and other criteria. For example, these criteria may pursue an investment in scholarship contracts which will have a yield sufficient to satisfy an annuity requirement for a CLAT 132, which is fixed from time to time by the Internal Revenue Service. The present invention's modeling and financial structuring capabilities can be used by a scholarship investor 102-106 to assist them in making certain investment and allocation decisions based on the scholarship investor's 102-106 individual estate, income tax, cash flow and charitable goals. The ASI system 101 can generate a description of proposed scholarship contracts; projected returns associated with the scholarship contracts and actual performance of the scholarship contracts. All information contained in the ASI system 101 can be displayed via a hardcopy, voice emulation, graphical user interface (GUI) or other convenient medium.

One product embodying this invention can include a fractional share of a portfolio 125 or basket of scholarship candidate contracts. A portfolio 125 of scholarship candidate contracts can be set up as unit investment trust or an open end fund, wherein the total amount of shares outstanding within the trust can fluctuate daily according to investment interest.

Another product embodying the present invention can include a security relating to a predetermined group of scholarship candidate contracts. A security can be created, for example, by investing assets in predetermined scholarship candidate contracts. If desired, scholarship candidate contracts upon which a security is based can have a shared characteristic. Alternatively, the scholarship candidate contracts upon which a security is based can have dissimilar characteristics which can be utilized to create a hedging effect as per any particular characteristic. A security can include a closed end fund of scholarship candidate contracts, which has a fixed number of shares outstanding, and a constant portfolio 125 invested exclusively in a specified set of scholarship candidate contracts. The resultant shares can be a new security which will replicate the performance of those contracts purchased. This new security can then be listed on a securities exchange and traded. After trading begins, linked derivative securities can also be listed and traded. In this manner, scholarship candidate contracts, when securitized, can be listed on a stock exchange and traded at any second, minute or hour.

Still another embodiment can include creating a corporation wherein corporate assets include specific scholarship candidate contracts. Shares in the corporation can be traded according to the value of the contracts held.

The invention can also act as a hedge for market makers who wish to lay off their risk of making markets in options on the underlying scholarship candidate contracts. In addition, scholarship investors 102-106 will be able to leverage their investments and be able to place, open, stop loss, market, limit orders or other type of order when buying or selling scholarship candidate contracts or portfolio funds of scholarship candidate contracts. Scholarship investor 102-106 can purchase or sell shares of securitized contract funds immediately by making a phone call to their broker, or by electronic trading. The securitized scholarship contract funds can have a fixed number of shares to provide stability of asset levels and scholarship investors 102-106 will be able to sell shares short quicker, and with greater liquidity.

The present invention includes the ability to trade a contract related to a scholarship candidate's 111-114 future earnings or an index of securitized scholarship candidate contracts with linked derivative products. Scholarship investors 102-106 are able to own multiple portfolio funds of scholarship candidate contracts in an effort to diversify their investment portfolios, much like a mutual fund of traditional securities. An index of scholarship candidate contracts can allow greater diversification, lower transaction costs, expanded investment choices and the ability to measure scholarship candidate contract fund performance against a relevant benchmark index. The index could be calculated many different ways with a great deal of flexibility: equal price weighted, capitalization weighted, or geometrically weighted, depending upon a specific need.

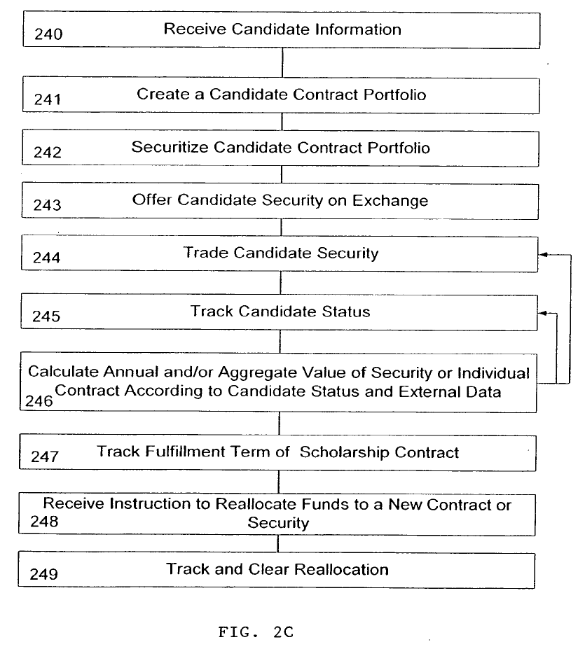

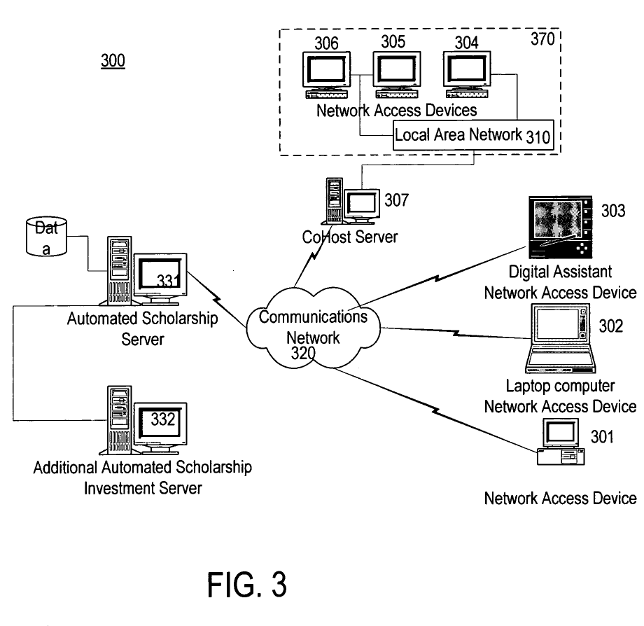

An electronic database, implementations of which are further discussed below in FIG. 3, database 345, can contain statistical information including scholarship candidate contract investment fund statistics that are registered in the defined country or geographic area. The statistics can be stored in the ASI system 101 and used for analysis. Data stored in the database can include scholarship fund financial data including fund value for a given time period, portfolio 125 composition, investment objective, load adjusted and unadjusted return, maximum sales charge, median market capitalization, daily, monthly, quarterly, yearly, multi-year returns, standard deviation, historical risk/reward ratios, distribution adjusted earning, payout ratio, potential capital gains exposure, price ratios, prospectus, purchase constraints, redemption fees, sector weighting, shareholder fees, total return, total return percentile, turnover ratio, deferred fees, manager name, manager tenure, class of shares, brokerage availability and other related information. It will be understood that not all of this information is required to practice the claimed invention.

A computer program algorithm can be created responsive to a query by an interested party, such as a scholarship investor 102-106, a fund manager, or an investment manager 131. The algorithm can act as a filter eliminating from a search all scholarship candidate contracts that do not fit within the criteria and present a list of those scholarship candidate contracts that do meet the criteria or store those contracts within a new section of the computer memory. A time period (t) for which statistics will be analyzed can also be specified. In addition, a scholarship candidate contract or portfolio 125 of contracts can be ranked based upon its performance over specific time periods.

A group of scholarship candidate contracts in a portfolio 125 can also be defined by specific investment criteria. This criteria may include a major fund investment objective such as a find of first round draft picks in a major league sport, or first year attorneys in major law firms in the New York area. Other fund groupings or queries to ascertain specific individuals can include for example, scholarship candidates obtaining a particular IQ score, scholarship candidates with a particular genetic trait, or descended from a class of ancestors, scholarship candidates from a specific geographic area, scholarship candidates of a particular nationality, or almost any other ascertainable attribute with which a scholarship candidate 111-114 can distinguish themselves.

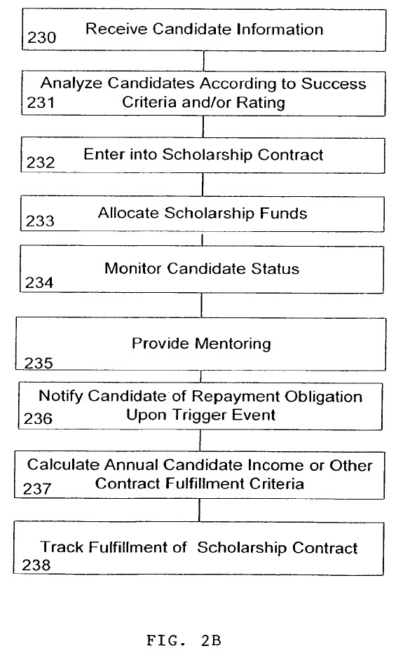

Referring now to FIG. 2a, a flow of an exemplary computerized process 200 for providing automated scholarship candidate investment is illustrated. The ASI system 101 can receive informational data descriptive of a scholarship candidate and the candidate's qualifications 210. Information can be received as data that is input directly into the ASI system 101 with a computer input device, such as a keyboard, pointing device, voice recognition or other device. In one example a GUI or application program interface (API) can be utilized to ease the data input. Data can also be received via an electronic communication, such as a data feed, e-mail, or scholarship candidate 111-114 submission. Typically the data will be received into structured fields in a database 145, however, data can also be received as unstructured information, such as in the form of an abstract, biography or resume descriptive of a scholarship candidate 111-114.

Scholarship candidate information can include any data descriptive of a scholarship candidate 111-114 that may be of interest to a potential scholarship investor 102-106 or other interested party, such as, for example, an investment facilitator 124. Scholarship candidate 111-114 information may include objective and/or subjective data; biographical information; demographic information; information descriptive of a scholarship candidate's accomplishments, test scores, political objectives, business objectives, academic objectives or other information relating to a scholarship candidate 111-114 and/or the scholarship candidate's 111-114 intended plans.

The ASI system 101 can also receive scholarship investment criteria 211 indicative of attributes, qualities, accomplishments and/or investment details specified by a scholarship investor 102-106 to be conditions precedent to investment in a scholarship. Examples of investment criteria can include, for example, a rate of return on investment to the scholarship investor 102-106; increasing the tax leverage of a scholarship investor's 102-106 charitable giving; a projected after tax financial return sufficiently in excess of an IRS annuity factor applicable to CLAT 132 to meet a scholarship investor's 102-106 return criteria for heirs; participation in a particular industry; scholarship candidates who attend a particular learning institution or curriculum; scholarship candidates who possess particular attributes; scholarship candidates from a particular lineage or possessing certain genetic characteristics; or any other criteria put forth as pertinent to investment in a scholarship candidate 111-114. Presentation of the criteria to a scholarship investor 102-106 can be accomplished via hardcopy, via an electronic interface, such as a GUI or via any other convenient medium.

The ASI system 101 can analyze the scholarship candidate 111-114 information according to the investment criteria 212 in order to determine those scholarship candidates that meet the criteria set forth by a specific scholarship investor 102-106.

Results of the analysis according to investment criteria can be presented via a GUI, text document, printed report, electronic message, or other method 213.

Presentation 213 of candidate analysis can be accomplished electronically via a model generated by the computerized ASI system 101, through a hardcopy prospectus, or other communication media. In one embodiment, a GUI can be utilized to present the investment criteria 213 and scholarship candidate 111-114 attributes. If appropriate, a scholarship investment structuring model can be generated by the ASI system 101 and present how a candidate can meet scholarship investment criteria 213. For example, if investment criteria include a philanthropic motive, the model can illustrate how a particular scholarship candidate 111-114 or portfolio 125 of scholarship candidates addresses the philanthropic motive. If criteria include financial objectives, the ASI system 101 can generate financial models which can illustrate how a candidate with the qualifications quantified will meet those objectives. Analysis can also include a qualitative rating or success quotient associated with the candidate, such as a confidence rating discussed above.

In another embodiment, the ASI system 101 can present scholarship candidate information for browsing 214. Browsing can also be accomplished, for example, through an electronic interface or via a printed document. Browsing can let a potential investor 102-106 or investment manager 131 to leisurely read about candidates 111-114 and determine An instruction to invest in a scholarship candidate 111-114 can be received 215 by the ASI system 101. Typically, an investment instruction will be received from a scholarship investor 102-106 that has been identified to the ASI system 101 and for whom credit limits and/or collateral arrangements have been previously arranged. However, in the event such payment arrangements have not been made, the ASI system 101 can branch to an automated system for quantifying payment terms, or refer the scholarship investor 102-106 to an account representative.

Funds can be allocated according to a scholarship investment instruction received 216. In those instances where it is required, approval for an instruction received can be accepted via a an electronic signature, logon password, secure ID, or any other well-known method for identifying a user accessing a computer system that can be utilized to sufficiently associate an instruction with a particular scholarship investor 102-106. In addition to other well known methods, allocation can be accomplished via disbursement of funds managed by the ASI system provider, via an instruction to a financial institution, or by transfer directly from scholarship investor 102-106 to a scholarship candidate.

The ASI system 101 can also track an ongoing candidate status 217 including attributes, financial data or other information related to the scholarship candidate 111-114. Capital calls or other investment installments into an investment entity can be made contingent upon the attainment of interim or final goals set for the scholarship candidate 111-114 and can also be tracked by ASI system 101. The attainment of interim or final goals can increase the value of a scholarship investor's 102-106 position in a scholarship candidate 111-114. The position of a scholarship investor 102-106 can be traded or otherwise transferred. Therefore, interim goals can be key to a scholarship investor's 102-106 exit strategy.

An ASI system 101 can also be utilized to track activities relating to the management of a scholarship candidate contract and/or portfolio 125 of scholarship candidate contracts. The ASI system 101 can present, or otherwise output relevant information, at set intervals, upon request, or on an ongoing basis. For example, an automated scholarship candidate investment provider 115, such as a philanthropic trust, a financial institution, or an educational institution can receive finds from a scholarship investor 102-106 and distribute the finds according to a schedule quantified in a scholarship candidate 111-114 contract and entered into the ASI system 101.

The scholarship candidate investment provider 115 may also receive information relating to a scholarship candidate 111-114 on an ongoing basis and input this information into the ASI system 101. Received information can include information enabling the ASI to calculate a candidate's annual income 218 and/or track fulfillment of scholarship contract terms 219. Salary information can be according to filed income tax statements or through a financial audit conducted according to the terms of a scholarship contract. The ASI system 101 can subsequently present stored information to a scholarship investor 102-106 or other party, or output the information as electronic data compatible with a computer system. If appropriate, funds can be allocated to an associated scholarship investor 220 or CLAT 132. Similarly, when a remuneration period is entered into, the ASI system 101 can be utilized to coordinate payments to the scholarship investor 102-106 and track the payments and related information in the ASI system 101.

The ASI system 101 can also receive ongoing information updates relating to scholarship candidates 221. Updated information can include, for example, demographic information, contact information, personal asset information, career status, additional education, or any other information.

The updated information received can be utilized to further analysis related to candidate success and refine success algorithms and models such that future predictions should be able to become increasingly accurate 222. For example, if an initial computer model indicated that a member of a class of graduates from a particular university with computer science degrees should obtain a certain level of success, updated information can either confirm or contradict the model. In addition, updated information should be able to factor in additional variables, such as geographic location of employment for the graduates, or the effect of obtaining advanced degrees. The refined models should become increasingly accurate at predicting the success of candidates. The refined algorithms and models can in turn be utilized to analyze subsequent candidates and investment criteria 223 such that each cycle should add to the accuracy of the models.

A website or other interface such as a GUI can be used in addition to hardcopy to make information related to candidates available to investors 224. An investor 102-106 can perform an analysis of their own, or browse the information, highlights in order to further their knowledge of the marketplace for scholarship investment. One example of information that can be made available is a comparison of initial scholarship 111-114 candidate qualifications to updated data that may indicate a measure of the candidate's success 225.

The GUI can also be programmed to enable the ASI system 101 to accept input which directs the ASI system 101 to perform an analysis of scholarship candidate 111-114 information thereby facilitating the making of informed decisions concerning investment or holdings in a scholarship candidate associated with a particular learning institution, industry type, geographic area, religious affiliation, ethnic background or other criteria. In addition, the ASI system 101 can calculate and present specific details relating to an investment vehicle. For example, an ASI system 101 can generate a report illustrating the value of an ownership interest in a particular LLC or the value of shares in a scholarship contract with a particular candidate, or the value of shares in a portfolio 125 of scholarship contracts.

Referring now to FIG. 2b, a flow of steps from the perspective of a scholarship provider is presented. These steps can be accomplished through the use of an ASI system 101. The scholarship provider can receive candidate information 230 and analyze the candidate information according to success criteria 231. A scholarship contract can be entered into with those candidates that the scholarship provider finds acceptable 232. Funds can be allocated 233 according to the terms of the scholarship contract entered into. In one embodiment, the ASI system 101 can automatically transfer the funds, such as through a wire transfer or through a clearing function with a university or other learning institution for which the funds are designated on behalf of the scholarship candidate 111-114. In any for of disbursement, the ASI system 101 can be utilized to record fund allocation.

The status of the scholarship candidate can be monitored 234 and mentoring provided if desired 235. Mentoring can be established at the outset of the scholarship contract relationship. In this case, a scholarship investor 102-106 may agree to set up regular meetings to review a scholarship recipient's 133 progress. In addition, mentoring can include summer employment or an internship during which the investor 102-106 can help impart a skill and experience that the scholarship recipient 133 may need to succeed. Both the investor 102-106 and the scholarship recipient 133 will benefit from the success of the recipient 133.

The ASI system 101 can implement notification to the scholarship candidate and the investor 102-106 of a trigger event 236 that will cause a repayment period to commence. The notification can include the terms of the repayment that the scholarship candidate has contracted for. In addition, the notification can include a request for information necessary to calculate scholarship contract fulfillment criteria. Once the necessary information has been received, the ASI system 101 can make any calculation necessary to fulfill the contract 237. In, one embodiment, a scholarship contract can include a term that calls for a minimum repayment amount in the event that all necessary information is not available to calculate the contracted terms of repayment. The ASI system 101 can also be utilized to track fulfillment of a scholarship contract 238.

Referring now to FIG. 2c, a flow of steps that can be included in a process for trading a security whose price is determined according to the value of underlying scholarship contracts is illustrated. An ASI system 101 can receive candidate information 240 and identify one or more scholarship contracts for which a security will be formed 241. If multiple contracts will underlie the security, a portfolio of candidates can be created. As discussed above, the portfolio of candidates can be formed according to a common characteristic or specifically diverse characteristics.

A security can be formed based upon the underlying scholarship contract or portfolio 242. If warranted, a security can be formed based upon a portfolio of one contract. For example, a contract may be formed with an exceptionally talented scholarship candidate, such as a very promising athlete or other prodigy. In this embodiment, a tradable security can be formed and traded that will track the success of the individual candidate.

The scholarship contract security can be offered for trade on a securities exchange 243, or other trading forum, such as over the counter. A contract that has not been incorporated into a security can also be traded if desired. For the sake of this discussion pertaining to trading of a security, it should be noted that a contract or portfolio of contracts can be substituted for a security based upon an underlying contract or portfolio of contracts. Material descriptive of the contracts underlying the security can be published when the security is offered for sale. The contract security can be traded 244 for any price that the market will bear. Prices can fluctuate for example according to world events, investor sentiment or the performance of the candidates underlying the security.

The ASI system 101 can be utilized to track candidate status 245 and model expected performance based upon informational updates. Updating can be accomplished on an ongoing or periodic basis. A calculation, such as an annual and/or aggregate value of a security or individual contract can be also made and utilized to determine a trading value 246. The candidate status can be used in conjunction with external data to make such a calculation.

The ASI system 101 can also track and publish fulfillment of scholarship contract to term 247 or receive an instruction to reallocate funds to a new contract, portfolio or security 248. Reallocations, and any other trading move, can be tracked and cleared 249 utilizing the ASI system 101.

The computerized ASI system 101 can also receive instructions to reallocate funds associated with a particular investment 248 and track reallocation of the funds according to the instruction received 249. For example, reallocation may involve selling a position in a portfolio of contracts for third year Yale students enrolled in a Computer Science curriculum and purchasing shares in a portfolio 125 of graduating law students from Columbia Law School wherein the law students all have engineering undergraduate degrees. Other functions of the computerized ASI system 101 can include transmitting or displaying an investment history 223. The investment history can be, for example, a history related to a particular scholarship candidate 111-114 or portfolio 125, or a history related to a particular LLC 103, learning institution, business venture, or other specification.

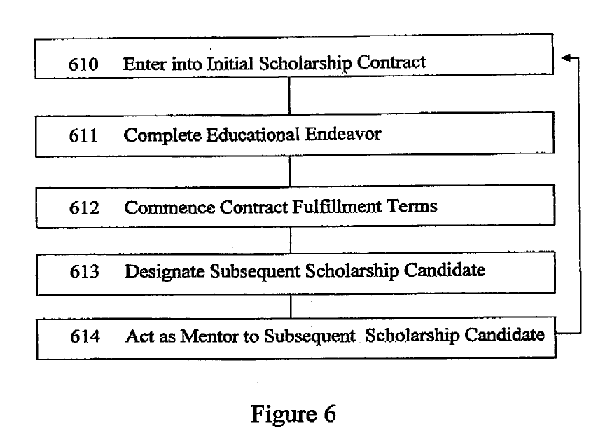

Referring now to FIG. 6, in one exemplary embodiment, terms of a scholarship contract can allow a scholarship recipient 133 to fulfill the terms of the scholarship contract and then designate a subsequent candidate to receive an offer for scholarship. The initial scholarship recipient 133 would enter into an initial scholarship contract 610 and complete the agreed upon educational endeavor 611. The scholarship recipient 133 would then enter into a payback period during which they would commence fulfillment of the contract terms 612. A portion of monies that were collected according to the contract fulfillment could then be allocated to provide subsequent scholarships. The initial scholarship recipient 133 would designate any subsequent scholarship candidates 111-114 who would receive a scholarship contract offer 613 using the allocated monies. The initial scholarship recipient 133 could also act as mentor to the subsequent candidate 111-114 to whom a scholarship if offered 614.

If desired, limitations can be placed upon choices for subsequent scholarship. For example, a scholarship may need to be offered to the alma mater of the initial scholarship recipient 133, or a scholarship provider may have to approve subsequent scholarship offers.

FIG. 3 shows a network of computerized devices 301-307, 331-333 that may be used in an implementation of an automated system for facilitating investment in scholarship contracts. The network 300 includes an automated scholarship server 331 or other host system and one or more network access devices 301-306, such as a personal computer, laptop, personal digital assistant, handheld computer or other wireless device, or other device that provides access to a resource available on a distributed network. Each of the network access devices can include a processor, memory, a user input device, such as a keyboard and/or mouse, and a user output device, such as a video display and/or printer. The network access devices 301-306 can communicate with the scholarship server 331 to obtain data stored at the scholarship server 331. The network access device 301-306 may interact with the automated scholarship server 331 as if the automated scholarship server 331 was a single entity in the network 300. However, the automated scholarship server 331 may include multiple processing and database sub-systems, such as cooperative or redundant processing and/or an additional server 332 that can be geographically dispersed throughout the network 300. In addition, there may be more than one occurrence of a host server 331. In some implementations, groups of network access devices 304-306 may communicate with scholarship server 331 through a co-host server 307. The co-host server 307 may be a proxy server or a caching server.

The automated scholarship server 331 includes one or more databases 345 which can store data relating to a scholarship candidate 111-114, a scholarship investor 102-106, market data 115, a charity, learning institution, past performance of investment in scholarship candidates, or other information conducive to making investment in a scholarship candidate 111-114. A database 345 can be a relational database, a hierarchical database or any other structure. A large variety of investment related materials may be stored at the scholarship server 331, for example, text, data, charts, audio, video, graphics, animations, and illustrations. In addition, the scholarship server 331 may interact with, and gather data from a user at a network access device 301-306. Data gathered from the user may be used for making investments in a scholarship candidate's future, fulfilling terms of a scholarship candidate contract, allocating money, investing in underlying institutions or entities, and any other activity associated with investment in a scholarship contract.

A user can access the automated scholarship server 331 using client software executed at the user's computer 301-306. The client software may include a generic hypertext markup language (HTML) browser, such as Netscape Navigator or Microsoft Internet Explorer, (a “WEB browser”). The client software may also be a proprietary browser, and/or other host access software. In some cases, an executable program, such as a Java™ program, may be downloaded from the scholarship server 331 to the network access device and executed at the network access device.

The scholarship server 331 can receive multiple forms of data as input. For example, the scholarship server 331 may receive data descriptive of a scholarship candidate 111-114, market data, demographic data, financial data or other. Data can be received as text input into fields on a form presented on a GUI, or received via an electronic data feed, such as from a government agency, news feed or commercial data provider such as Bloomberg. Received data can be structured and organized into a format conducive to referencing, such as a database table.

The scholarship can also be linked to a trading exchange 333 either through the network 320 or through a direct link or data pipe 334. Trade executions or clearing functions can be transmitted back and forth between the scholarship server and a front or back end system in the trading exchange. Trades can be cleared via a software program running on the ASI system 101, through the trading exchange, or through a third party clearinghouse.

The invention may be implemented in digital electronic circuitry, or in computer hardware, firmware, software, or in combinations of them. Apparatus of the invention may be implemented in a computer program product tangibly embodied in a machine-readable storage device for execution by a programmable processor; and method steps of the invention may be performed by a programmable processor executing a program of instructions to perform functions of the invention by operating on input data and generating output. Preferably the invention will be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors.

Computers 301-307 331-333, in a network 300 utilized to form an automated scholarship candidate investment system may be connected to each other by one or more network interconnection technologies. For example dial-up lines, token-ring and/or Ethernet networks 310, T1 lines, asynchronous transfer mode links, wireless links, cable modems and integrated service digital network (ISDN) connections may all be combined in the communications network 320. Other packet network and point-to-point interconnection technologies may also be used. Additionally, the functions associated with separate processing and database servers in the scholarship server 331 may be integrated into a single server system or may be partitioned among servers and database systems that are distributed over a wide geographic area.

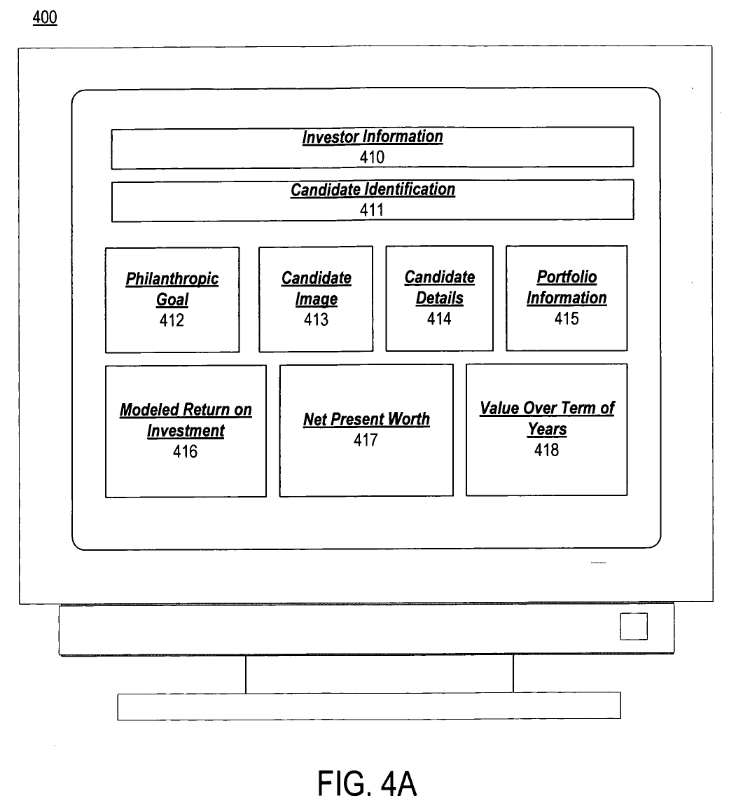

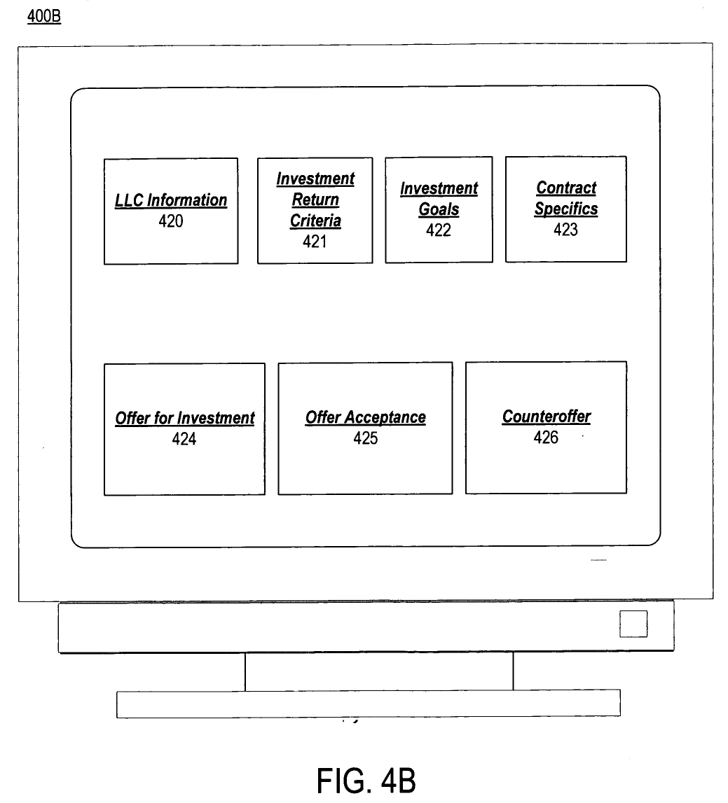

Referring now to FIG. 4a, an interactive GUI 400 operable in conjunction with a network access device, can be used to present the functions of an ASI system 101. Interactive user areas on the display can include: an area for investor information data 410, an area for scholarship candidate identification 411, an area relating to a philanthropic goal 412, an area containing an image of a candidate 413, an area containing detailed information relating to a candidate 414 and an area for details relating to a portfolio 125 in which a scholarship candidate may be included 415.

Additional interactive areas that can be incorporated into a GUI according to the present invention include an area to display a modeled return on investment 416, an area to display a net present worth of a contract 417 and an area to display a value over a term of years 418.

Referring now to FIG. 4b, a GUI is illustrated that contains a display with an area for information related to an LLC that holds a contract with the scholarship candidate 420. Other interactive areas can include an interactive area to display or input investment return criteria 421, investment goals 422, and/or details pertaining to contract specifics 423. In one embodiment, a GUI can include an interactive area that enables a scholarship investor 102-106 to make an offer for investment 424 in a scholarship candidate 111-114. The offer may indicate standard terms as discussed previously, or specific terms that can be further detailed by the scholarship investor 102-106. Additionally an interactive area can be included that enables a scholarship candidate 111-114 to accept an offer 425 for a contract, or make a counter offer 426.

A scholarship candidate 111-114 can accept an offer for investment, make a counter offer, or present an original offer via a scholarship candidate GUI. A contract can be generated in hardcopy and executed manually by each party, or a contract can be executed via the ASI system 101 through the use of electronic signatures that are legally binding. In addition, or alternatively, a provider of an ASI system 101 can enter into contract with a scholarship candidate 111-114 binding the scholarship candidate 111-114 to investment terms entered into by the ASI system 101 or other transaction medium.

The GUI interactive areas 410-418 420-426 can include user interactive devices such as editable fields, or icons, to enable functions for the entry, display and editing of information. For example, the area for scholarship investor data 410 can allow entry, display and editing of data including the name of a scholarship investor, address, age, tax identification number, such as a social security number, age, and other details related to the investor. An area for scholarship candidate data can contain similar type data as well as proposed initiatives, future goals, and data descriptive of any facet of the scholarship candidate's life, including demographic data.

Other interactive areas can include similar interactive devices and functions for data related to each area. Accordingly, for example and in no way limiting the scope of available data fields, an interactive area for scholarship candidate related information detail 414 can allow entry, display and editing of data such as the scholarship candidate name and tax identification number, as well as the scholarship candidate's address, contact information, age, relation to the notable genetic lineage, and other details or demographics descriptive of the scholarship candidate. This area can also include scholarship candidate achievements, personal and professional accomplishments or other achievements of a scholarship candidate 412. Examples of achievements can include academic degrees earned, business achievements, athletic achievements, awards received, publications authored, or other achievements. The GUI can also include interactive portions to allow entry, display and editing of information descriptive of nationality; personal physical attributes, such as a handicap or exceptional capability or feature; relation to the notable genetic lineage; and other details.

Similarly, an area for details relating to an LLC can include interactive areas allowing entry, display and editing of information related to an LLC, such as the owner, trustee, name, legal details, or other information. An interactive area for investment goals 416 can include, for example, a required cash flow over a term of years, feasible upsides to an investment, benefits that may arise from a statutory deduction for donation to a charitable organization, or any other information relating to the financial benefits of a specific investment property. Additional details can include, for example, charitable gift giving intentions over a term of years, tax planning data, transfer of wealth relating to estate planning, cash flow needs of the scholarship investor and any other goals specific to an individual scholarship investor.

The area for investment structure 418 can include specific recommendations for financial investment, which will satisfy the investment goals while utilizing the underlying assets. The specific recommendations can include, for example, an amount of money which needs to be invested or a term of years for a contract.

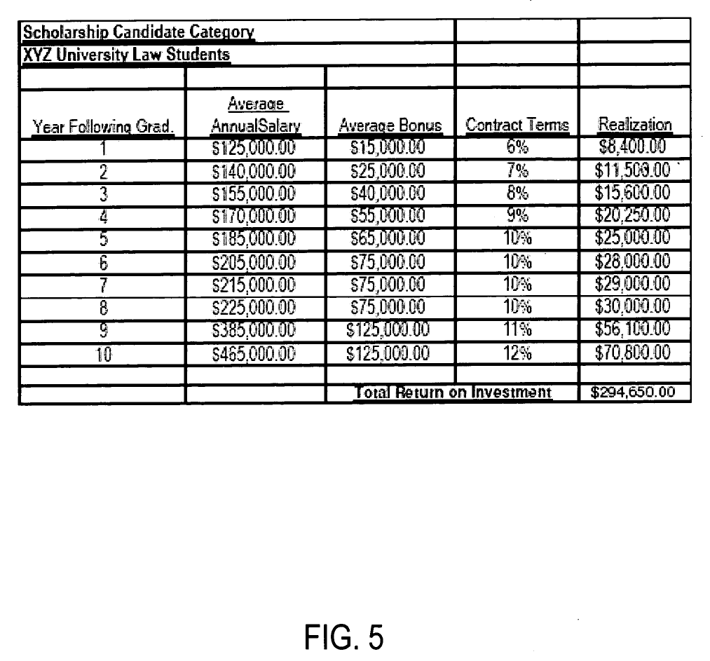

Referring now to FIG. 5, an example of one analysis relating to a scholarship that calls for a percentage of earnings over a period of ten years. A scholarship candidate category 500 is defined. In this case it is defined as law school students at New York University. A column indicates each year following graduation 511 for the scholarship recipient 133. Other columns indicate the average annual salary 512 and the average annual bonus 513 received by graduates of New York University's School of Law. The ninth and tenth year following graduation show a significant increase as the graduates typically make partner. What is not illustrated in this example is the potential for a significant upside if the scholarship recipient 133 turns out to be highly successful.

A column can also illustrate the terms of the scholarship contract entered into. In the exemplary case illustrated the terms are a simple graduated percent of earnings 514, from which an annual realization can be calculated 515. A total return on investment 516 can also be calculated and displayed.

While the above description contains many specific examples, these should not be construed as limitations on the scope of the invention, but rather as an exemplification of one preferred embodiment thereof. Many variations are possible, for example, the ASI system 101 can facilitate investment in a corporate training program meant to place up and coming employees in a position to further succeed. If the corporation is reticent to make a substantial investment in training their employees for fear that the employee may receive the training and then depart for another place of employment, the corporation can enter into a contract with the employee which will guarantee that the corporation is reimbursed for its training effort no matter where the employee decides to be employed.

While a number of embodiments of the present invention have been described, it will be understood that various modifications may be made without departing from the spirit and scope of the invention. For example, network access devices 301-307 can comprise a personal computer executing an operating system such as Microsoft Windows™, UNIX™, Linux or Apple MacOS™, as well as software applications, such as a web browser. Network access devices 301-307 can also be terminal devices, or a palm-type computer WEB access device that adheres to a point-to-point or network communication protocol such as the Internet protocol. Other examples can include TV WEB browsers, terminals and wireless access devices (such as a 3-Com Palm organizer). A network access device may include a processor, RAM and/or ROM memory, a display capability, an input device and hard disk or other relatively permanent storage. Interactive graphical user interfaces specifically related to information generated as a result of the workings of the financial structuring system can include any information contained within databases relating to the financial structure, or derivative of such information.

Other functionality and details not specifically listed can also be included in the spirit of the present invention. Accordingly, other embodiments are included within the scope of the following claims.

1. A computerized apparatus for facilitating a financial investment in one or more scholarship candidates, the system comprising:
a computer server accessible with a network access device via a communication network; and
executable software stored on the server and executable on demand via the network access device, the software operative with the server to cause the server to:
receive digital data descriptive of an investment scholarship candidate;
transmit at least a portion of the digital data to a network access device associated with a potential scholarship investor; and
receive an instruction from the potential scholarship investor to make an investment of funds in a scholarship contract to which the scholarship candidate is a party based upon the digital data descriptive of the investment scholarship candidate.

2. The computerized apparatus of claim 1, wherein the software is additionally operative to cause the server to execute a financial transaction transferring funds based upon the instruction received.

3. The computerized apparatus of claim 1 wherein the software is additionally operative to cause the server to generate a human readable interface available via a distribute network for accessing the digital data descriptive of an investment scholarship candidate.

4. The computerized apparatus of claim 3 wherein the executable software additionally comprises instructions for causing the server to generate a human readable interface for receiving an instruction to make the investment in a scholarship contract to which the scholarship candidate is a party based upon the digital data descriptive of the investment scholarship candidate.

5. The computerized apparatus of claim 1, wherein the scholarship contract comprises terms for financial performance and the executable software additionally comprises instructions for causing the server to track a return on investment funds made in the scholarship contract over a period of time.

6. The computerized apparatus of claim 1 wherein the software is additionally operative to cause the server to model an expected return on investment according to terms of the scholarship contract and an indicator of expectations for future performance of the scholarship candidate.

7. The computerized apparatus of claim 1 wherein the software is additionally operative to cause the server to calculate a success rating indicative of the scholarship contract terms expected performance.

8. The computerized apparatus of claim 7 wherein the success rating is calculated according to a success algorithm executed by the computer server.

9. The computerized apparatus of claim 8 wherein the software is additionally operative to cause the server to receive an instruction to form an investment vehicle comprising a portfolio of scholarship contracts; and receive an investment instruction to make an investment in the investment vehicle.

10. The computerized apparatus of claim 9 wherein the investment vehicle is a limited liability company.

11. The computerized apparatus of claim 9 wherein the instruction to form an investment vehicle comprising a portfolio of scholarship contracts comprises contracts associated with two or more scholarship candidates selected by an investor creating the investment instruction.

12. The computerized apparatus of claim 1 wherein the software is additionally operative to cause the server to:
track a scholarship candidate's status and fulfillment of contract terms; and
allocate funds based upon the candidate status and fulfillment of contract terms.

13. The computerized apparatus of claim 1 wherein the software is additionally operative to cause the server to:
receive data descriptive of the scholarship candidate status; and
model an expected return on investment according to terms of the scholarship contract and the data descriptive of the scholarship candidate status.

14. The computerized apparatus of claim 1 wherein the software is additionally operative to cause the server to:
present model an expected return on investment according to terms of the scholarship contract and the data descriptive of the scholarship candidate status via a human readable graphical user interface.

15. The computerized apparatus of claim 15 wherein the software is additionally operative to cause the server to:
identify a portfolio of scholarship contracts;
structure a financial product that can be traded as a security comprising ownership of the scholarship contracts; and
determine a price of the financial product based upon information descriptive of the portfolio of scholarship contracts.

16. The computerized apparatus of claim 1 wherein the software is additionally operative to cause the server to:
transmit data descriptive of the financial product that can be traded as a security, wherein the price of the financial product is based upon information descriptive of one or more scholarship contracts.

17. The computerized apparatus of claim 1 wherein the software is additionally operative to cause the server to:
transmit data descriptive of the financial product that can be traded as a security, wherein the price of the financial product is based upon information a scaled rating indicative of a degree of confidence in one or more scholarship candidates' likelihood of success.

18. The computerized apparatus of claim 1 wherein the potential scholarship investor to make an investment of funds in a scholarship contract comprises an entity that is eligible to be a charitable lead annuity trust.

19. The computerized apparatus of claim 1 wherein the executable software additionally comprises instructions for causing the server to receive a communication from the potential investor identifying a scholarship recipient.

20. The computerized apparatus of claim 1 wherein the executable software additionally comprises instructions for causing the server to structure a scholarship investment as a charitable donation.
